(19) United States
(12) Patent Application Publication
(10) Pub. No.: US 2013/0344760 A1
(43) Pub. Date: Dec. 26, 2013

(54) INSULATION SYSTEM

(71) Applicant: Madawaska Doors Inc., Ontario (CA)

(72) Inventor: Michael James Snider, Ontario (CA)

(73) Assignee: Madawaska Doors Inc., Ontario (CA)

(21) Appl. No.: 13/922,108

(22) Filed: Jun. 19, 2013

(30) Foreign Application Priority Data
Jun. 20, 2012 (CA) 2780413

(51) Int. Cl. E06B 5/16

(52) U.S. Cl. CPC E06B 5/16
USPC 442/181

(57) ABSTRACT

An insulation system is provided, including a first wooden panel and a second wooden panel, each having interior and exterior faces. An insulation layer composed of woven silica-based aerogel interwoven with silicone-based reinforcing coating, and having first and second surfaces is bonded to such wood panels through use of an adhesive layer positioned between surfaces and the panels. The system provides a thermal resistance or R-value in excess

### FIELD OF INVENTION

The present disclosure relates to an insulation system for use in construction and residential and commercial applications that is fire resistant and prevents and/or delays heat and cold transfer.

### BACKGROUND OF THE INVENTION

Wood has historically been a preferred material for use in construction applications. It supports customized construction, and is both renewable and biodegradable. Wood provides an aesthetically pleasing appearance, and provides users with a known, robust feel, rather than feeling flimsy or artificial. However, wood has its drawbacks in certain applications. It is not flame resistant, and performs poorly as an insulating material. Failed attempts have been made at providing construction materials exhibiting both the aforementioned advantageous properties of wood as well as advantageous thermal efficiency and fire-resistance.

Thermal efficiency is an ever increasing concern, as consumers look to minimize expenses of heating and cooling their homes and places of business, while looking as well to minimize their impact on the environment. High resistance to flame is important as it can increase the time taken for fires to move from one chamber to another, allowing greater time for responders to fight such fires, and preserving property and perhaps lives in the process.

Doors used in residential and many commercial applications are typically about 1¾ to 2¾ inches thick. It is desirable to maintain such an approximate thickness to fit with industry standard components and avoid obtrusiveness when in an open position. It is desirable for doors to exhibit thermal resistance, or what are commonly known in the construction industry, as “R-values” in excess of 10, and an ability to resist flame such that burning through of any door takes in excess of an hour. These goals cannot be achieved by doors composed solely of wood.

In order to achieve such performance, doors have been provided with cavities filled with insulating foams. Such doors can typically only provide the general appearance of wood, as providing a thickness of foam sufficient to meet thermal resistance requirements leaves only a very thin outer layer of wood, essentially a veneer. This results in a relatively lightweight, shoddy feeling door. Typically, veneer layers can be susceptible of chipping or other marking, as they do not exhibit the capacity of thicker layers of wood to absorb impact. They are also vulnerable to delamination due to moisture infiltration, limiting their durability and aesthetic appeal. In addition, doors of this type are not readily suitable for customization, such as cutting to particular shapes, adding ornamental articles, adding windows, and the like. The types of foams used, including for example polyurethane foam, require precaution during manufacturing and installation as they and, in particular, dust created when they are cut, can be harmful to humans.

Other doors have been provided with metal outer shells surrounding cavities of insulation foam. These doors can be extremely resistant to flames, and can exhibit reasonable R-values in excess of 10-12. However, and aside from obviously not exhibiting the desired aesthetic properties, such doors can be extremely heavy and are not at all suited to customization. As such, they are suitable only for more industrial and institutional applications and are poorly suited to residential construction applications.

Materials exist that perform better as insulation than do the aforementioned insulating foams. Some of these include, for example, aerogels (i.e., gel-derived porous materials wherein gel components have been replaced with gases). These materials exhibit extremely low thermal conductivity; however, they have not typically been employed in construction applications due to their relatively brittle and inflexible nature. These properties result in difficulty with effectively binding or affixing any aerogel materials to other construction materials without impairing the integrity of the aerogel or otherwise losing some of its advantageous properties. More recently, these aerogel materials have been provided with reinforcing layers of additional materials, lessening the aforementioned disadvantage.

It has not been possible to construct doors maintaining the foregoing advantageous properties and still achieving exemplary thermal resistance. It is preferable to achieve higher R-values, and for some uses R-values in excess of about 12. Wooden materials are not typically capable of such performance unless supplemented by additional materials, which also serve to lessen the appeal of such material for use in construction applications. As such, prior art systems have not allowed for the use of wooden doors unless consumers sacrifice thermal efficiency and fire safety for aesthetic purposes.

Disclosed embodiments overcome the above-described disadvantages of the prior art.

### SUMMARY OF THE INVENTION

In accordance with disclosed embodiments herein, an insulation system is provided comprising a first wooden panel and a second wooden panel, each having interior and exterior faces. An insulation layer is also provided, comprising woven silica-based aerogel interwoven with silicone-based reinforcing coating, and having first and second surfaces. There is an adhesive layer positioned between and bonding the surfaces and the panels. Insulation systems of this embodiment can provide a thermal resistance or R-value in excess of 10.

Each of the surfaces may be shaped to the interior face of a respective one of the panels. In disclosed embodiments, the adhesive layer or layers may comprise a silicone-based adhesive. In disclosed embodiments, the insulation layer has a thickness of approximately 0.160 inches, and may be formed from one or more sub-layers, bonded together. In disclosed embodiments, the insulation layer comprises a substantially planar, flexible mat. In disclosed embodiments, the boundaries of the insulation layer are substantially contiguous with those of the panels.

In another aspect of the disclosed embodiments, there is provided an insulation system comprising a first wooden door panel having interior and exterior faces, and a second wooden door panel having interior and exterior faces. There is also provided an insulation layer composed of woven silica-based aerogel interwoven with a silicone-based reinforcing coating, and having first and second surfaces. The first and second surfaces are each affixed to a respective one of the interior face of the first wooden panel and the interior face of the second wooden panel, with the system providing a thermal resistance or R-value in excess of 10.

In some embodiments the insulation layer has a thickness of between 0.160 and 0.200 inches. The adhesive layer in systems implementing the disclosed embodiments can resist flame to a temperature of at least 800 degrees Fahrenheit for at least 90 minutes. In another aspect of the disclosed embodiments, there are provided two substrate layers and an insulating layer interposed between those layers. The substrate layer may be comprised of wood and the insulating layer may be made of woven silicone-based aerogel interwoven with a silicone-based reinforcing coating, and has a thickness of less than 0.200 inches, with the system providing a thermal resistance or R-value in excess of 10. The substrate layers and the insulating layer in disclosed embodiments have a combined thickness of less than approximately two inches.

### BRIEF DESCRIPTION OF THE DRAWINGS

FIG. 1 is a right side perspective view of a system according to embodiments described herein;

FIG. 2 is an expanded, sectional view along line 1-1 shown in FIG. 1; and

FIG. 3 is an exploded view of the view shown in FIG. 2.

The present embodiments will now be described hereinafter with reference to the accompanying drawings, which form a part hereof, and which illustrate example embodiments which may be practiced. As used in the disclosures and the appended claims, the terms “embodiment” and “example embodiment” do not necessarily refer to a single embodiment, although it may, and various example embodiments may be readily combined and interchanged, without departing from the scope or spirit of the present embodiments. Furthermore, the terminology as used herein is for the purpose of describing example embodiments only, and are not intended to be limitations. In this respect, as used herein, the term “in” may include “in” and “on,” and the terms “a,” “an” and “the” may include singular and plural references. Furthermore, as used herein, the term “by” may also mean “from,” depending on the context. Furthermore, as used herein, the term “if” may also mean “when” or “upon,” depending on the context. Furthermore, as used herein, the words “and/or” may refer to and encompass any and all possible combinations of one or more of the associated listed items.

Although similar reference numbers may be used to refer to similar elements for convenience, it can be appreciated that each of the various example embodiments are considered to be distinct variations.

### DETAILED DESCRIPTION OF THE INVENTION

Disclosed herein is an insulation system 10 comprising a first wooden panel 20 and a second wooden panel 30. Each of the wooden panels 20, 30 may be provided as a unitary piece or may be comprised of multiple conjoined wooden pieces. Some other materials may be included in the panels 20, 30 but may be predominantly made up of wood. Many types of wood may be used, including for example pine, hemlock, cedar, poplar, mahogany, oak, cherry, ash, walnut, teak, birch, fir and various other specialty woods.

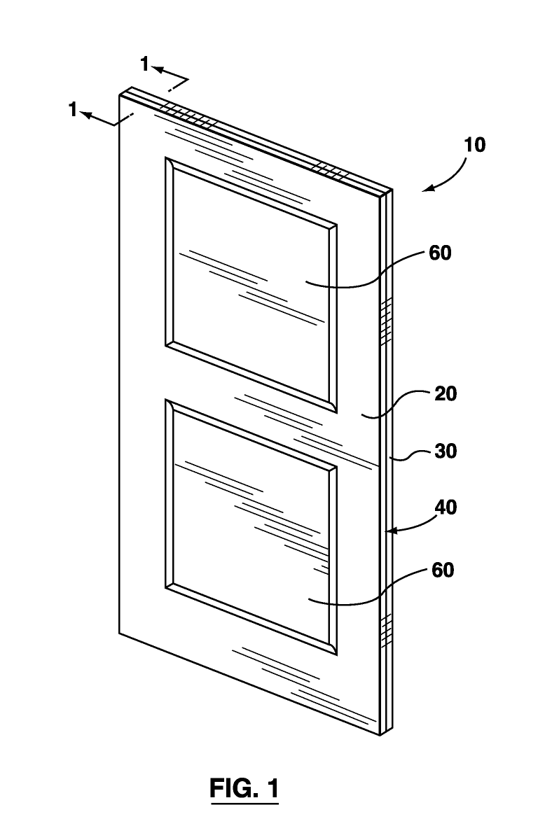

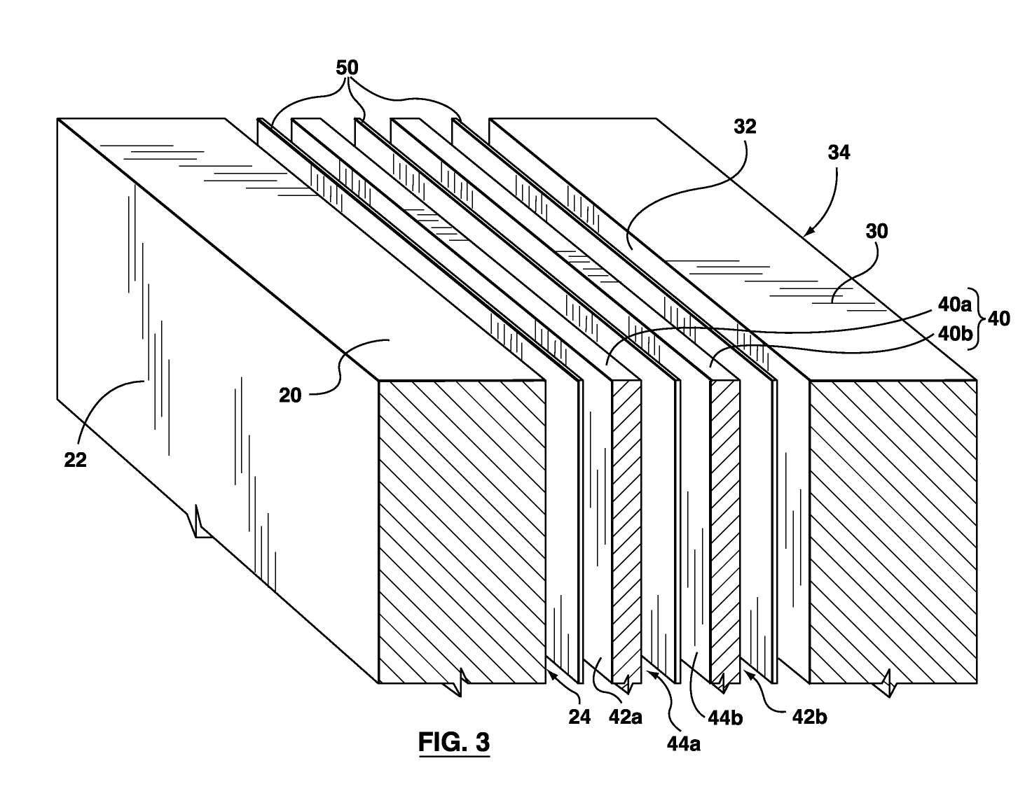

The first wooden panel 20 has interior 22 and exterior 24 faces, and the second wooden panel 30 has interior 32 and exterior 34 faces, as best shown in FIG. 3. Trim or other decorative articles composed of wood or other materials may be applied to the respective exterior faces 24, 34, as shown, for example, in FIG. 1. Door opening and locking hardware such as handles, locks, hinges (not shown) and the like can of course be provided with systems made in accordance with embodiments disclosed herein.

An insulation layer 40 is also provided, and is composed of woven silica-based aerogel interwoven with silicone-based reinforcing coating. Providing the aerogel insulation in such a form and with the coating allows for binding of the layer to without fear of failure due to stress or brittleness.

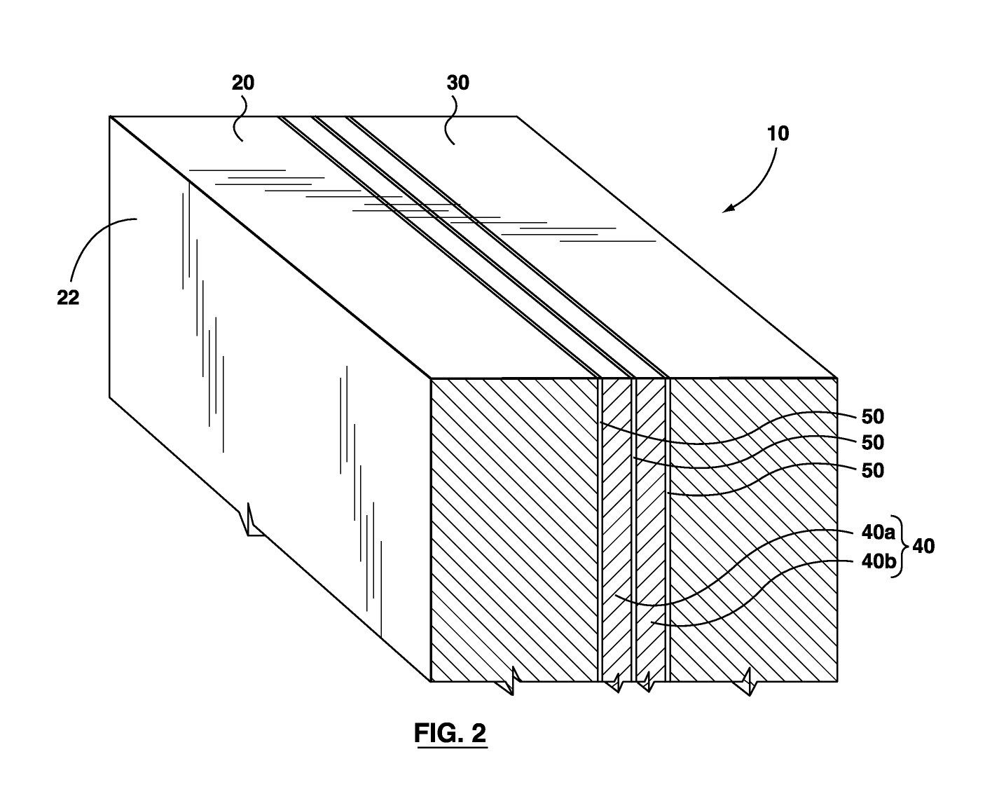

Each insulating layer 40 has first 42 and second 44 surfaces. The insulating layer 40 may be comprised of conjoined a plurality of sub-layers 40a, 40b, each having their own sets of first and second surfaces (42a, 44a and 42b, 44b, respectively), as best shown in FIG. 2. While two sub-layers 40a, 40b are shown in the Figures, more sub-layers may be used in some embodiments. In disclosed embodiments, the combined thickness of all sub-layers 40a, 40b insulating layers 40 may be less than 0.200 inches. In other disclosed embodiments, this combined thickness of all sub-layers 40a, 40b and insulating layers 40 may be less than 0.16 inches. Minimizing thickness of the insulating layer 40 minimizes differences in workability and customizability of any doors assembled according to the disclosed embodiments, as compared to using a solid wood structure. For example, processing systems designed for construction and customization of conventional wooden doors may likewise be used to customize (e.g., add windows, trim or other ornamental articles) the system 10. Further, these low thicknesses allow for provision of, for example, conventional thickness doors, minimizing the difference in feel and construction requirements while optimizing thermal performance. The first 42 and second 44 surfaces of the insulating layer 40 and the panels 20, 30, and bound to them by an adhesive layer 50. When multiple sub-layers 40a, 40b are provided, the first 42a, 42b and second 44a, 44b surfaces of each will be arranged such that the sub-layers 40a and 40b are bound to one another by adhesive and the insulating layer 40 they comprise will be similarly bound to the panels 20, 30. Multiple orders of operation are possible in terms of assembling the system 10. For ease of illustration, the adhesive layer 50 is shown in FIG. 3 as a planar sheet. However, the adhesive layer 50 may not be provided in such form, and could, for example, be a unitary or binary compound applied to one or both of the surfaces 42, 44 of the insulating layer 40 facing the panels 20, 30 (and between the sub-layers 40a, 40b, if provided). The adhesive may itself be resistant to temperatures in excess of 800 degrees Fahrenheit.

For the purposes of the present description, the term “R-value” refers to a measure of thermal resistance, as is commonly used in the construction industry in reference to insulation. It commonly refers to the heat lost across a unit thickness for a unit area of a material. The higher the R-values, the better the insulation.

When multiple layers of materials are employed, they typically function in a manner analogous to electrical resistors applied in series, i.e., the resistance of the various materials are summed. However, as disclosed herein, providing the discussed insulating layer 40 as part of the system 10 produced overall system 10 R-values well in excess of what was expected. That is, while various components of the system 10 are themselves known, when provided in the claimed configurations, unexpectedly high thermal resistance levels or R-values can be achieved using the principles disclosed herein. For example, the use of woods in door construction typically yields in doors that provides a thermal resistance of about 1-1.5 per inch of wood thickness. A wooden door of conventional thickness (i.e. 1¾ to 2¾″) cannot achieve thermal resistance values in excess of about 10-12, as are achieved by the system 10. Further, these results may be achieved without substantially thickening the door, or losing any of the advantageous properties inherent to using wood, as discussed herein.

As also discussed above, aerogel based insulation is not known to be used in construction applications. Such materials are typically too brittle and susceptible to breakage and shear, and cannot be affixed by way of adhesives or other means without high risk of physical failure, until more recent, advanced versions were employed outside the construction industry.

The present system 10 advantageously and unexpectedly allows for the use of an insulating layer 40 with a total thickness of about 0.160 inches, between wood panels of thicknesses that add with the insulating layer 40, to a total thickness less than 2 inches (it is noted that the thicknesses of the wood panels need not match each other), and that can yield an R-value in excess of 12. According to design needs, some embodiments may have a total thickness of less than approximately 1.5 inches.

Thus further, advantageous property of the system 10 may be provided by using even a thinner insulating layer 40 (e.g., less than 0.100″ thick). Such configurations will not, however, achieve R-values in excess of 10-12, but will provide R-values of about 6.

For example, providing an insulating layer with a thickness of about 0.080 inches may result in R-values in excess of about 6.0, as well as a comparable level of resistance to flame as with thicker insulating layers and not previously possible in the field of solid wood doors.

Thus, a system built using the presently disclosed embodiments would be the first to provide, for example, a door with the look, feel and customizable nature of a conventional wood design, including a total thickness less on the order of about 2-3 inches, with an R-value in excess of 12. Further, wooden doors are not capable of withstanding fire nearly so well as is the case with this system 10.

In some disclosed embodiments, the surfaces 44, 46 of the insulation layer 40 may be contoured each to the interior face 22, 32 of a respective one of said first panel 20 and said second panel 30. This may be achieved by custom forming of the insulation layer 40 or by abutment of a flexible mat configuration of the insulation layer 40 to the panels, and subsequent for forming thereto during assembly.

The adhesive layer 50 may comprise a silicone-based adhesive that is resistant to flame. One skilled in the art will appreciate that other types of adhesives exhibiting similar properties could likewise be employed as part of the system 10.

The insulation layer 40 may be provided in a substantially planar, flexible mat form. This may facilitate ease of manufacture of the system 10. The insulation layer 40 may extend so as to have boundaries substantially contiguous with those of the panels 20, 30. It may alternatively be provided so as to extend short of any such boundaries (for design or other considerations). In such instances, some thermal resistance will be lost.

The system 10 may be sized, shaped and altered in substantially the same way as if it was an existing non-insulated wood door panels. This is an advantage over conventional insulated doors, as each requires more cumbersome and, indeed, more final manufacturing methodologies. As but one example, windows 60 may be provided in the system 10, as shown in FIG. 1.

The system 10 may be used with an ultra thin insulating layer 40, as described herein, between layers 20, 30 of substrates which, while disclosed as wood in described embodiments herein, need not necessarily be that material. The substrate layers 20,30 need not each be composed of the same material and may alternatively be comprised of various other materials of use in construction applications or other suitable materials. Examples include floor and sub-floor layers, foundation components such as concrete blocks and the like, exterior siding, and drywall. As in other embodiments, advantageous R-value levels are achieved without substantially altering the typical thickness of the related hardware. For example, insulation layers 40 of thicknesses of about 0.160 inches could be provided in flooring applications, too.

The embodiments described herein are illustrative of the present disclosure and are not intended to limit the scope of the disclosure to the particular embodiments described. It will be appreciated by those skilled in the art that various changes can be made therein without departing from the spirit of the disclosure.

While various embodiments have been described above, it should be understood that they have been presented by way of example only, and not limitation. Thus, the breadth and scope of a preferred embodiment should not be limited by any of the above described exemplary embodiments, but should be defined only in accordance with the claims and their equivalents for any patent that issues claiming priority from this specification.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under applicable patent rules or otherwise to provide organizational cues. These headings shall not limit or characterize the invention(s) set out in any claims that may issue from this disclosure. Specifically and by way of example, although the headings refer to a “Field of the Invention,” such claims should not be limited by the language chosen under this heading to describe the so-called field.

Further, a description of a technology in the “Background of the Invention” is not to be construed as an admission that technology or any described shortcoming is prior art to any invention(s) in this disclosure. Neither is the “Summary of the Invention” to be considered as a characterization of the invention(s) set forth in issued claims. Furthermore, any reference in this disclosure to “invention” in the singular should not be used to argue that there is only a single point of novelty in this disclosure.

Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. An insulation system comprising:
a first wooden panel and a second wooden panel, each having interior and exterior faces;
an insulation layer comprised of a woven silica-based aerogel interwoven with a silicone-based reinforcing coating, and having first and second surfaces;
an adhesive layer positioned between and bonding said surfaces and said panels;
whereby the system provides an R-value in excess of 10.

2. The insulation system of claim 1, wherein each of said surfaces is shaped to the interior face of a respective one of said first panel and said second panel.

3. The system of claim 1, wherein said adhesive layer comprises a silicone-based adhesive.

4. The insulation system of claim 3, wherein the insulation layer has a thickness of between 0.160 and 0.200 inches

5. The insulation system of claim 4, wherein the insulation layer comprises one or more sub-layers bonded together to form said insulation layer.

6. The insulation system of claim 1, wherein the insulation layer is a substantially planar, flexible mat.

7. The system of claim 1, wherein said insulation layer has boundaries substantially contiguous with those of said panels.

8. An insulation system comprising:
a first wooden door panel having interior and exterior faces;
a second wooden door panel having interior and exterior faces;
an insulation layer composed of a woven silica-based aerogel interwoven with silicone-based reinforcing coating, wherein said insulation has first and second surfaces, and
wherein said first and second surfaces are each affixed to a respective one of said interior face of said first wooden panel and said interior face of said second wooden panel;
whereby the system provides an R-value in excess of 10.

9. The insulation system of claim 8, further comprising an adhesive layer positioned between the interior faces of said first and second door panels and said insulation layer to affix said insulation layer to said interior faces.

10. The insulation system of claim 9, wherein the adhesive layer comprises a silicone-based adhesive.

11. The insulation system of claim 8, wherein the system provides a thermal resistance of a value in excess of 10.

12. The insulation system of claim 11, wherein the insulation layer has a thickness between 0.160 and 0.200 inches.

13. The insulation system of claim 10, wherein the adhesive layer can resist flame to a temperature of at least 800 degrees Fahrenheit for at least 90 minutes.

14. An insulation system, wherein said system comprises:
two substrate layers and an insulating layer interposed between said substrate layers;
wherein said insulating layer is comprised of a woven silica-based aerogel interwoven with a silicone-based reinforcing coating, and has a thickness of less than 0.20 inches; and
wherein said system provides a thermal resistance or R-value in excess of 10.

15. The system of claim 14, wherein said substrate layers are comprised of wood.

16. The system of claim 14, wherein said insulating layer has a thickness between 0.160 and 0.200 inches.

17. The system of claim 14, wherein said insulating layer has a thickness of less than 0.160 inches.

18. The system of claim 16, wherein the insulating layer comprises at least two conjoined sub-layers.

19. The system of claim 18, wherein said insulating layer is a substantially planar, flexible mat that is shaped to interior surfaces of each of said substrate layers;

20. The system of claim 19, wherein said insulating layer is formed to have outer boundaries contiguous with those of said substrate layers.
